(19) United States
(12) Patent Application Publication
(10) Pub. No.: US 2014/0323157 A1
(43) Pub. Date: Oct. 30, 2014

(54) SYSTEMS AND METHODS FOR HAZARDOUS MATERIAL SIMULATIONS AND GAMES USING INTERNET-CONNECTED MOBILE DEVICES

(71) Applicant: IMAGE INSIGHT INC., East Hartford, CT (US)

(72) Inventors: Gordon A. DRUKIER, New Haven, CT (US); Peter R. SOLOMON, W. Hartford, CT (US); Gregory Nicholas BENES, Lincoln, MA (US); Eric P. RUBENSTEIN, Longmeadow, MA (US)

(73) Assignee: IMAGE INSIGHT INC., East Hartford, CT (US)

(21) Appl. No.: 14/262,038

(22) Filed: Apr. 25, 2014

Related U.S. Application Data
(60) Provisional application No. 61/816,320, filed on Apr. 26, 2013.

(51) Int. Cl. H04W 4/02

(52) U.S. Cl. CPC H04W 4/023
USPC 455/456.3

(57) ABSTRACT

Embodiments of the invention are directed to systems, devices, and methods for using mobile devices to detect a simulated source, and games and training exercises using these systems, devices, and methods. In some embodiments, the source may be a simulated hazardous material that emits energy, particles, or vapors that can also be simulated by the mobile devices. In such embodiments, the systems, devices, and methods can be used to simulate an incident involving the release of hazardous materials such as, for example, a chemical or radioactive material spill or attack by chemical, biological, nuclear, or radioactive (dirty bomb) weapons. In other embodiments, the system can be used to simulate an object used in a game such as a ball, puck, or goal and monitor movement of the object and players using a mobile device.

### CROSS-REFERENCE TO RELATED APPLICATION

This application claims the priority benefit of U.S. Provisional Patent Application No. 61/816,320, filed Apr. 26, 2013 entitled “Systems and Methods for Hazardous Material Simulations and Games Using Internet-Connected Mobile Devices,” which is incorporated herein by reference in its entirety.

### BACKGROUND

Modern mobile devices like smartphones and tablets provide users with many diverse functions and applications including, but not limited to, phone communication, proximal location (for example, via global positioning satellites (GPS) or Wi-Fi based location), temperature, velocity and acceleration measurements, gravity vector, pressure, internet connectivity, pictures, and video. A large number of applications (apps) have been developed for mobile devices, which use and combine various functions to provide users with a broad range of useful capabilities. For example, a plurality of games exist that use the mobile device's sensors such as, for example, GPS, accelerometers, and communication via one or more data protocols. One such game, Geocaching™ is a treasure hunting game that uses real world locations via GPS or other location-aware devices for players to obtain GPS coordinates or other location information for hidden treasures (a geocache) from a Geocaching™ web site and use the information and/or their device's positioning to locate the geocache. Ingress™ and Shadow Cities™ are augmented reality games in which players on two teams use their device's GPS-derived position to compete for possession of portals that are established on a web server at places of public art, landmarks, parks, and/or the like, and are linked to create virtual triangular fields over geographic areas. Progress in the game is measured based upon a team that controls the most portals and territory. Tourality is another location-based game played in an urban district, park, or woods in which the player's location and movements are identified via GPS-signal transmitted to a server from the mobile device and the goal is to be the fastest player to move between locations. Geodashing is a game in which a number of random locations are chosen for each game, and the winner is a person or team that visits the most locations before a deadline. Waymarking provides a method of sharing coordinates using a device's GPS and details of interesting locations in order to build a community map of desirable places. In GPS Mission, the player is sent on a scavenger hunt adventure to reach destinations and answer questions. Confluences is a game dedicated to determining how certain GPS locations would appear in which players use their smartphone's GPS to go to locations or confluences and take a photo that is transmitted to the Confluences website. Project Tango uses a smartphone platform with a vision processor and position sensors to map 3-dimensional spaces.

GammaPix™ and Radioactivity Counter are smartphone applications that use the smartphone's camera to detect radioactivity. GammaPix™, which is described in U.S. Pat. No. 7,391,028, allows for measuring of radioactivity levels and transmission of the readings to a server for correlation and presentation with geospatial and temporal correlations to foster awareness of radiological measurements.

Other applications for mobile devices use these devices capabilities and additional hardware to allow chemical detection, air monitoring, leak detection, and hazardous agent detection. For example, the Department of Homeland Security's Science & Technology Directorate demonstrated the first-ever cell phone capable of detecting life-threatening chemical exposures, dubbed the Cell-All. Cell All is an environmental surveillance system that uses a typical cell phone as a platform for a sensor system to detect harmful chemical substances and transmit critical information, including location data, to first responder and other related monitoring agencies. The Cell All system is a personal environmental threat detector system, consisting of multiple sensors that are miniaturized into a device and applied on an individual's cell phone. The Cell All system will integrate sensors with cell phones to allow its users to continually test the surrounding environment for harmful substances and send alerts to a central monitoring agency (for example, First Responders) if it detects an exposure or abnormal quantities. These latter applications provide for personal safety and First Responder tools. However, they could also contribute to homeland security functions through crowd-sourcing in which millions of civilian mobile devices measure local radioactivity, biological composition and chemical composition and communicate the readings and their locations to First Responders.

Whether first responders use single purpose sensors or mobile devices like smartphones or tablets for hazard detection, they must be trained in the use of the device itself and how they are to be employed in an emergency. First Responders and incident commanders must be trained to locate the source of hazardous radioactive, biological or chemical emissions and establish safe cordon distances beyond which it is safe to operate and take other emergency action.

### SUMMARY

In an embodiment, a system may include one or more mobile devices. Each mobile device may have a display, a processor, a position determination sensor, and a means for communicating with a remote computing device. The system may further include a remote computing device having at least a processor, a means for communicating with each of the one or more mobile devices, and a readable storage medium. The readable storage medium may have instructions for simulating a source, calculating a field associated with the source, calculating an intensity of the field for each of the one or more mobile devices based on the location of the mobile device and a location of the source, and transmitting the intensity of the field to each individual mobile device.

In an embodiment, a method of providing a simulation may include simulating, by a processor, a source and determining, by the processor, a field surrounding the source. The field may be based upon one or more parameters. The method may further include determining, by the processor, an intensity of the field based upon the one or more parameters and a location relative to the source, transmitting, by the processor, information to a mobile device, transmitting, by the processor, the information to a command center, and receiving, by the processor, one or more commands from the command center. The information may correspond to the source, the field, and the intensity of the field at the location of the mobile device. The one or more commands may direct a user of the mobile device to complete one or more instructions. The method may further include transmitting, by the processor, the one or more commands to the mobile device.

In an embodiment, a system may include a processor and a non-transitory, processor readable storage medium. The non-transitory, processor readable storage device may include one or more programming instructions that, when executed, cause the processor to simulate a source and determine a field surrounding the source. The field may be based upon one or more parameters. The one or more programming instructions, when executed, may further cause the processor to determine an intensity of the field based upon the one or more parameters and a location relative to the source, transmit information to a mobile device, transmit the information to a command center, and receive one or more commands from the command center. The information may correspond to the source, the field, and the intensity of the field at the location of the mobile device. The one or more commands may direct a user of the mobile device to complete one or more instructions. The one or more programming instructions, when executed, may further cause the processor to transmit the one or more commands to the mobile device.

### DESCRIPTION OF DRAWINGS

FIG. 1 depicts a block diagram of a general system for detecting a simulated hazardous material source according to an embodiment.

FIG. 2 depicts an illustrative command center map with a simulated radiation source and a cordon according to an embodiment.

FIG. 3 depicts a block diagram of a detailed system for detecting a simulated hazardous material source according to an embodiment.

FIG. 4 depicts a block diagram of an illustrative system for determining a radioactive source intensity according to an embodiment.

FIG. 5 depicts a block diagram of an illustrative system for determining an intensity of a chemical or biological source according to an embodiment.

FIG. 6 depicts a block diagram of another system for determining an intensity of a chemical or biological source in the presence of a wind according to an embodiment.

FIG. 7 depicts a block diagram of an illustrative system of gamifying object detection according to an embodiment.

FIG. 8 depicts a block diagram of an illustrative system of gamifying object detection according to an embodiment.

FIG. 9 depicts a flow diagram of a method of providing a simulation according to an embodiment.

FIG. 10 depicts a block diagram of illustrative internal hardware that may be used to contain or implement program instructions, such as the process steps discussed herein, according to various embodiments.

### DETAILED DESCRIPTION

Before the present compositions and methods are described, it is to be understood that this invention is not limited to the particular compositions, methodologies or protocols described, as these may vary. It is also to be understood that the terminology used in the description is for the purpose of describing the particular versions or embodiments only, and is not intended to limit the scope of the present compositions and methods which will be limited only by the appended claims.

It must also be noted that as used herein and in the appended claims, the singular forms “a,” “an,” and “the” include plural reference unless the context clearly dictates otherwise. Thus, for example, reference to a “gamma ray” is a reference to one or more gamma rays and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference. Nothing herein is to be construed as an admission that the invention is not entitled to antedate such disclosure by virtue of prior invention.

“Optional” or “optionally” means that the subsequently described event or circumstance may or may not occur, and that the description includes instances where the event occurs and instances where it does not.

Embodiments of the invention are directed to systems, devices, and methods for using mobile devices to detect a simulated source, and games and training exercises using these systems, devices, and methods. In some embodiments, the systems, devices, and methods described herein may be implemented by a processing device and/or may be embodied by one or more programming instructions that instruct a processor to complete one or more processes. In some embodiments, the source may be a simulated hazardous material that emits energy, particles, or vapors that can be constrained to a particular location or distributed with a simulated density across an area. In such embodiments, the systems, devices, and methods can be used to simulate an incident involving the release of hazardous materials such as, for example, a chemical or radioactive material spill or attack by chemical, biological, nuclear (detonation or fall-out), or radioactive (dirty bomb) weapons. In other embodiments, the system can be used to simulate an object used in a game such as, for example, a ball or puck, a goal, a boundary, other players, and/or the like and may further monitor movement of various objects and/or players via a mobile device.

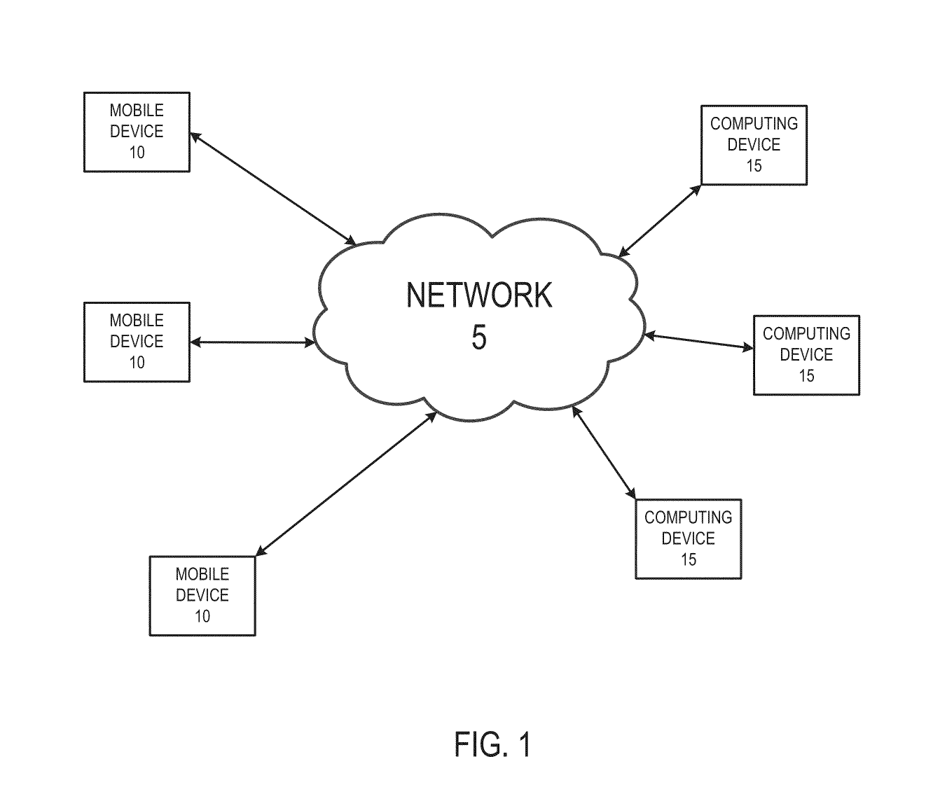

As depicted in FIG. 1, the systems of various embodiments may include one or more mobile devices 10 having a display, a processor, a location-aware component (for example, Global Positioning Satellite (“GPS”) component, a wi-fi location component, and an indoor positioning system) capability, and a means for communicating with one or more remote computing devices 15, such as, for example, a server. Each mobile device 10 may be configured to communicate with a remote computing device 15 via a network 5, such as, for example, the Internet, an intranet, a wide area network, a metropolitan area network, a local area network, an internet area network, a campus area network, a virtual private network, a personal network, and/or the like. For example, each mobile device 15 can transmit position information to a remote computing device 15 relating to the location of the mobile device. The remote computing device 15 can use this position information to determine relevant quantities such as, for example, simulated exposure rate, and transmit information about a simulated source material to the mobile device 10. A user may be provided the information via the mobile device 10. The communication between each mobile device 10 and a remote computing device 15 may occur intermittently or continually, thereby allowing a user to receive information related to the source in real time until one or more mobile devices is positioned at the source or at another suitable location to satisfy one or more goals of a training or a game, as described in greater detail herein. Two non-limiting examples may include mapping a fall-out zone and determining a locus of a simulated 2 milliroentgens per hour (mR/hr) dose-rate line, which may be established as a step in a process of controlling a radiological emergency scene.

The “source” refers to a simulated material that is positioned at a particular location. Information related to the source may vary among embodiments and may reflect the type of material that is being simulated and/or its distribution. For example, in some embodiments, the source may be simulated radioactive material, a nuclear device, or a dirty bomb. In such cases the “source” may be a discrete particle having a specified level of activity, or it may be a distribution such as may be derived analytically or experimentally, potentially using auxiliary software such as plume-modeling software (for example, HotSpot, PCTRAN, Visual Plumes, and/or the like). In other embodiments, the source may be a simulated chemical or biological weapon, and in still other embodiments, the source may be a completely fictionalized material or game piece.

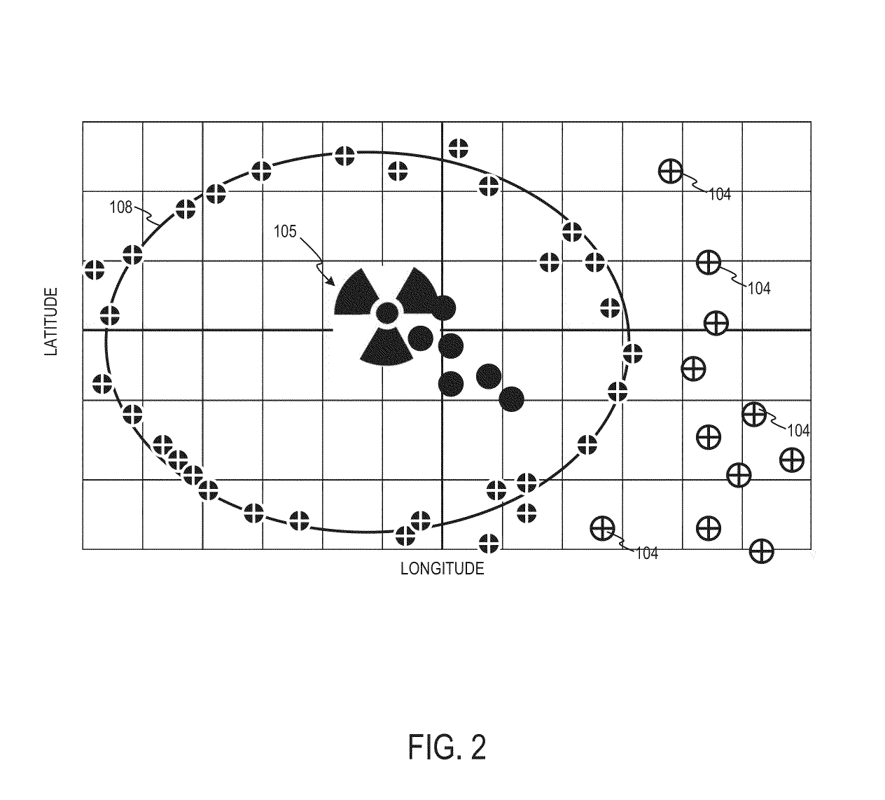

In some embodiments, as shown in FIGS. 2, 5, and 6, the source 105 may produce a field 107 or a “cloud” extending away from the source and diffusing, dispersing, or convecting away from the source. For example, the field 107 may be simulated energy, gamma radiation, concentrations of chemical vapors or particles, concentrations of biological particles, or fictional indicators of the presence of the source 105. As such, the source information transmitted by the remote computing device 15 to the mobile device 10 (FIG. 1) may become more intense as the mobile device moves closer to the source 105. For example, a mobile device 1 meter from a source 105 may receive source information having a much higher intensity than a mobile device 100 meters from the source.

In certain embodiments, the source 105 may simulate radiant energy from a hazardous radioactive material using known distance dependence of the radioactive field intensity. For example, in some embodiments, the source 105 may be a simulated chemical or biological agent, and source information may be a concentration of the chemical agent or biological agent based on known diffusion and convection rates of these agents given known, prevailing, or entirely simulated environmental parameters (such as, for example, temperature, wind speed, wind direction, presence and nature of structures, topological profile, humidity, altitude, barometric pressure, atmospheric composition, electric field, magnetic field, temperature, proximity, orientation, electric field, magnetic field, video, and still images and/or the like).

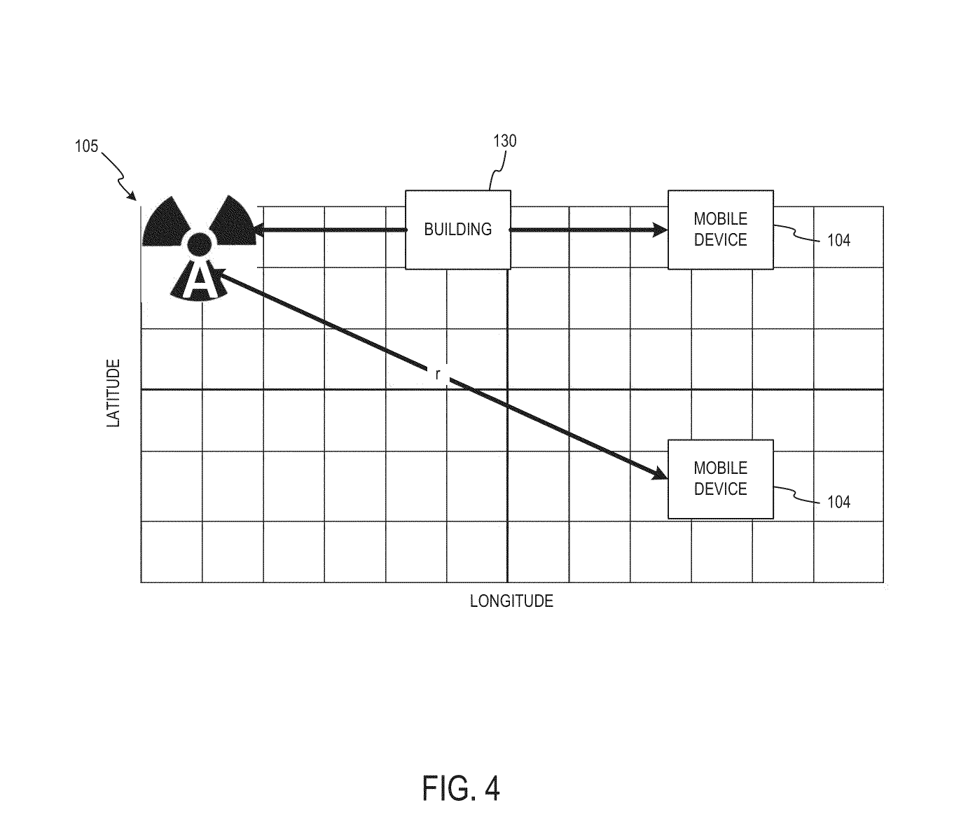

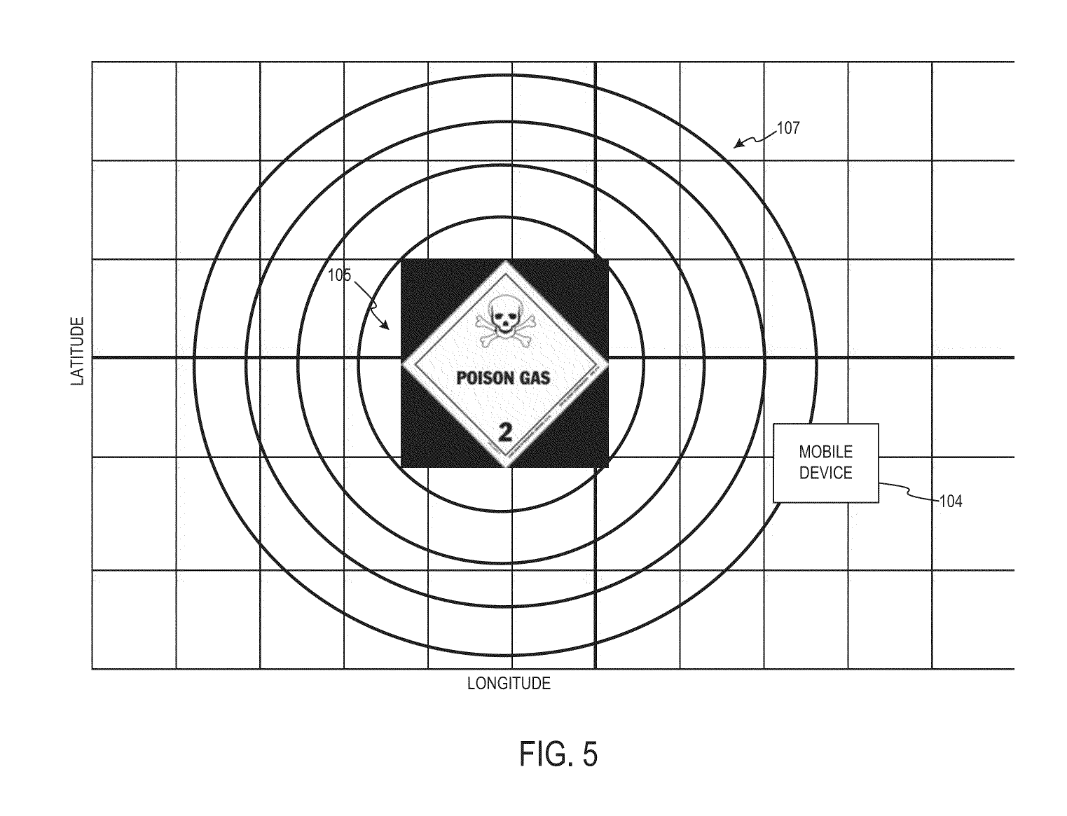

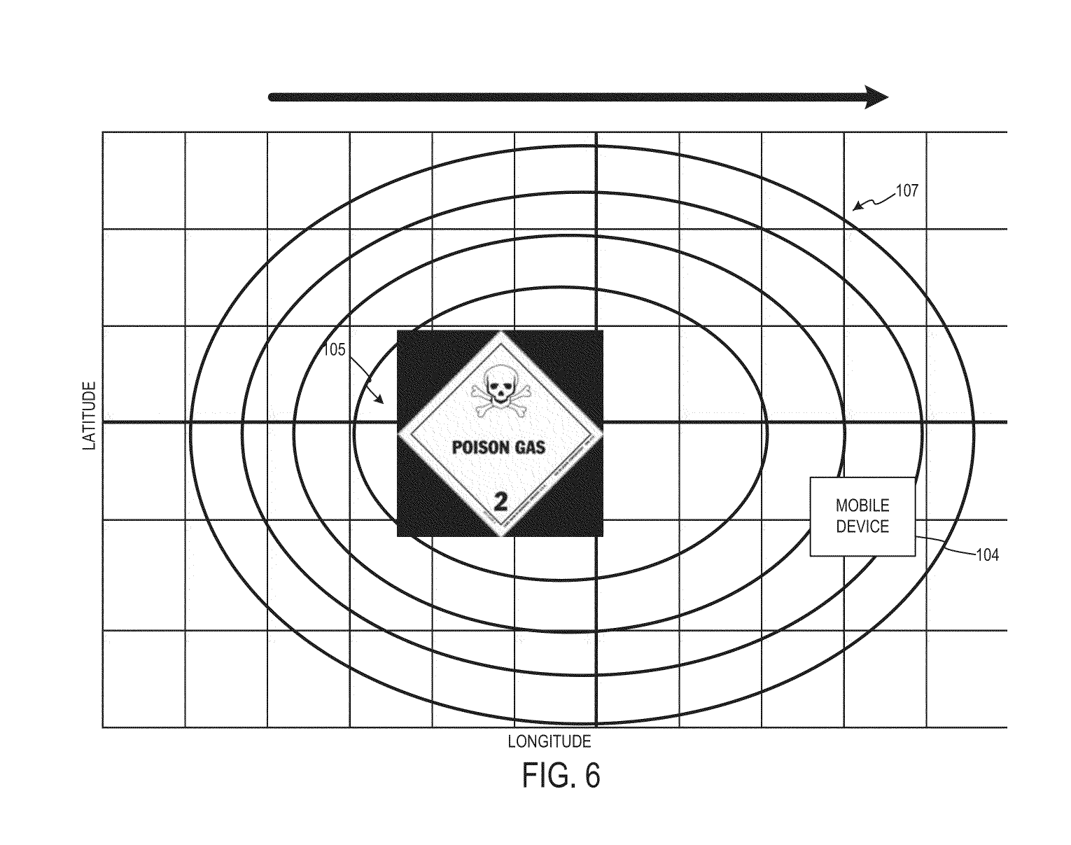

In particular embodiments, as shown in FIG. 5, the source may have known or simulated environmental parameters that result in equal intensity calculations (as represented by the rings) around the source. However, if a factor (such as wind) is introduced, the known or simulated environmental parameters may result in intensity calculations that move or change based on the environmental parameter (for example, in the direction of the wind, as indicated by the arrow in FIG. 6). As shown in FIG. 4, intensity may also be determined by the presence of obstacles, such as, for example, buildings 130 and/or the like. Thus, the intensity may be based on attenuation caused by the buildings 130 or terrain between each simulated source 105 and each mobile device 104. Intensity for radioactive sources may generally be determined by a formula ^{A}/r². The parameter, A, may be a constant related to the size of a source 105 and r is the distance from the simulated source to each of the one or more mobile devices 104. The intensity of the radioactive field for each of the one or more mobile devices is determined by a formula selected from the group consisting of ^{A}/r² wherein A is a constant related to the size of a source and r is the distance from the simulated source to each of the one or more mobile devices.

In other embodiments, the source 105 may be a simulated nuclear device, a Radiation Dispersal Device (RDD or “dirty bomb”), or a Radiation Exposure Device (RED or “silent source”) containing radioactive materials, and the source information may be simulated gamma emissions from the nuclear device or dirty bomb. In still other embodiments, the source 105 may be a fictional source having fabricated decay, emissions, and dispersion characteristics.

Returning to FIG. 1, in various embodiments, the remote computing device 15 may perform all calculations necessary to produce the simulated field 107 (FIGS. 5 and 6). As such, the remote computing device 15 may include a processor and memory containing processor readable instructions for simulating the field 107, as described in greater detail herein. The remote computing device 15 may further perform all calculations necessary to provide an appropriate intensity level for each mobile device 10 based on the location of the mobile device. As such, the remote computing device 15 may include memory containing instructions for obtaining location information such as, for example, GPS coordinates, from each mobile device 10 and instructions for calculating an intensity of the field at the location of each mobile device based on the result of simulating the field. Calculating the intensity of the field at the location of each mobile device 10 may be carried out continuously such that information transmitted to the mobile device from the remote computing device 15 may be up-to-date as the mobile device moves nearer to and farther away from the source. To transmit this information to mobile devices 10, the remote computing device 15 may also include instructions for transmitting the information to each mobile device. Transmitting can be carried out by any means of communication, including wired and wireless communication. Illustrative wireless communications include, but are not limited to, Wi-Fi, Li-Fi, Wi-Max, Long Term Evolution (LTE), high speed packet access (HSPA) Bluetooth, radio, and the like and combinations thereof. The remote computing device 15 may further include any devices and other means for carrying out such transmitting means. Instructions for the device itself may also be transmitted, such as, for example, instructions to change a frequency at which automatic measurements are performed.

In some embodiments, the simulated field may be based on a fixed source, and in other embodiments, simulated field may be based on a source that is moving. Therefore, the remote computing device 15 may further include instructions for simulating the field as the position of the source of the field changes and instructions for calculating the intensity of the field at the location of each mobile device based on the results of simulating the field as the position of the source changes. Calculating the intensity of the field at the location of each mobile device 10 may account for the location and the movement of the source and the location and the movement of each mobile device. Calculating the intensity of the field at the location of each mobile device 10 based on a moving source may be carried out continuously such that information transmitted to the mobile device from the remote computing device 15 may be up-to-date as the mobile device moves nearer to and farther away from the source and the source moves nearer and farther from each mobile device. In some embodiments, calculating the intensity of the field at the location of each mobile device 10 may be based upon a plurality of sources, including mixed sources (for example, a plurality of sources in the same general area) and distributed sources (for example, a plurality of sources in different areas).

Each mobile device 10 may include a display, a processor, memory, a location-determination capability, and a means for communicating with the remote computing device 15. The means for communicating with the remote computing device 15 may be any means compatible with the remote computing device including, for example, internet, Wi-Fi, Li-Fi, Wi-Max, LTE, HSPA, SMS, broad band connections, Bluetooth, radio, and the like and combinations thereof. In some embodiments, the mobile device 10 may communicate with the remote computing device 15 using multiple means simultaneously. The means of communicating with the remote computing device 15 may provide a two-way means for communicating with the remote computing device. For example, each mobile device 10 may include processor instructions for obtaining location information such as, for example, GPS coordinates, and transmitting the location information to the remote computing device 15. The remote computing device 15 may use this location information to calculate an intensity of the field for the mobile device 10 based on the location of the simulated source and transmit this information to the mobile device, as discussed herein. The mobile device 10 may obtain this information and may include processing instructions for displaying this information on the mobile device. The display may be any type of display. In some embodiments, the display may be a visual display such as, for example, a numerical intensity level, a color associated with the intensity level, a bar graph or other meter indicating intensity, a map, one or more shapes or textures on a map, a pointer indicating the direction of the source, and the like or combinations thereof. In other embodiments, the display may be an audible display such as, for example, beeps or other tones, which show intensity using increasing beeps per minute or higher or louder pitch as the intensity increases. In certain embodiments, the mobile device 10 may use one or more visual displays, audible displays, haptic feedback, and/or the like.

Embodiments are not limited to particular mobile devices. For example, in some embodiments, each mobile device 10 may be a cellular telephone. In other embodiments, each mobile device may be a specialized device for detecting, for example, chemical or biological agents, nuclear or radioactive material containing devices, bombs, environmental hazards such as natural gas, propane, oil, gasoline, fuel oil, liquid coal, radon, and the like and other materials that may be leaked from underground containers or pipelines, and the like and combinations thereof. Illustrative specialized devices include, but are not limited to, Geiger counters, scintillation counters, radioisotope measurement devices, spectrometers, biological agent detection devices, chemical agent detection devices, and the like. In other embodiments, one or more of the mobile devices 10 may be a designated remote computing device 15, and may carry on all assigned tasks for coordination and calculation as described herein. In still other embodiments, the system may incorporate a combination of such mobile devices 10.

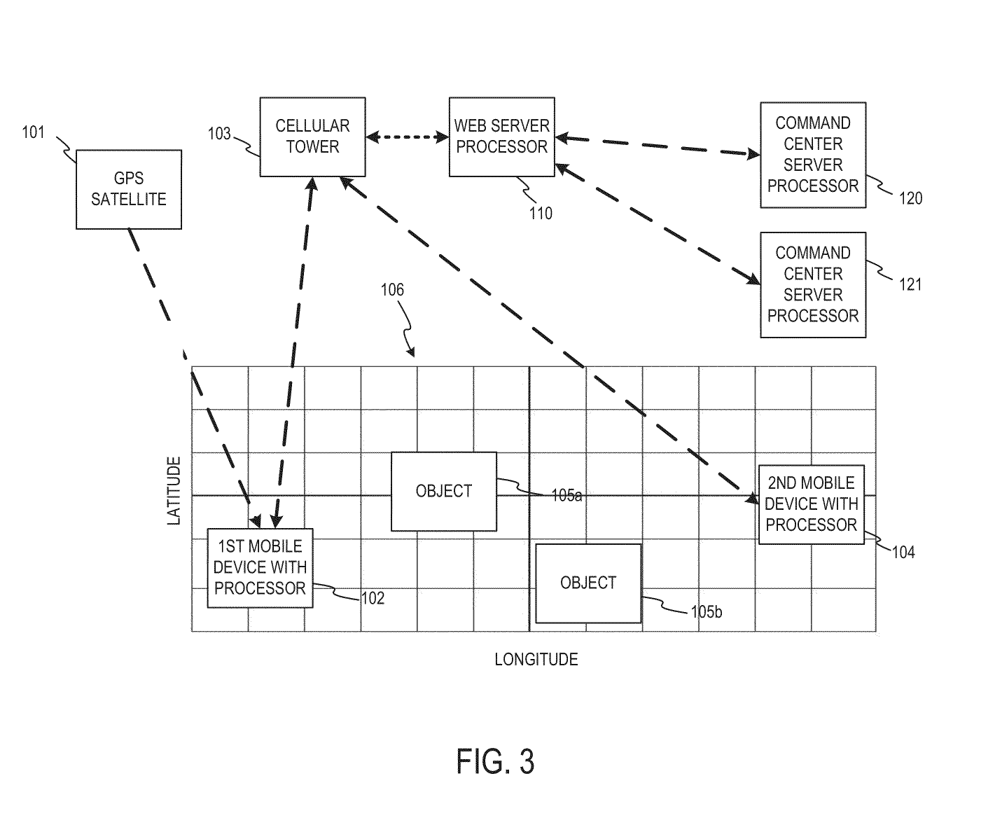

As shown in FIG. 3, in particular embodiments, the system may further include one or more command centers 120, 121. Each command center 120, 121 may include a processor, memory, a display, and a means for communicating with the remote computing device 110. The means for communicating with the remote computing device 110 may be any means compatible with the computing device including, for example, internet, Wi-Fi, Li-Fi, Wi-Max, LTE, HSPA, broad band connections, Bluetooth, radio, and the like and combinations thereof. In some embodiments, the mobile device 102 may communicate with the computing device 110 using multiple means simultaneously, and the means of communicating with the computing device may provide a two-way means for communicating with the computing device. In some embodiments, each command center 120, 121 may obtain location information for the simulated source and location information for each mobile device 102, 104. In some embodiments, the mobile device 102, 104 may contain one or more programming instructions that allows it to serve as a command center 120, 121 and may also be able to control aspects of the training scenario or game. The command center 120, 121 may further be capable of obtaining a graphical map of the area containing the simulated source and the mobile devices 102, 104. Such graphical maps may be obtained from the remote computing device 110 or an independent source such as an internet database, such as Google™ Maps. An illustrative graphical map is depicted in FIG. 2, where the source 105 may be shown as surrounded by a cordon 108 and/or the location(s) of the one or more mobile devices 104. The cordon 108 may generally represent an area surrounding the source 105 at which it is safe for users of the mobile devices 104 to move. For example, the area inside the cordon 108 may be unsafe, whereas the area outside the cordon is safe. Referring back to FIG. 3, the command center 120, 121 may include processor executable instructions for displaying a map and superimposing the location of the simulated source and the location of each mobile device 102, 104 on the map. The location information for both the simulated source and each mobile device 102, 104 may be updated continuously thereby providing a command center user with the location for all of the mobile devices in communication with the remote computing device 110.

In some embodiments, the command center 120, 121 may further include a means for communicating with the one or more mobile devices 102, 104. For example, the command center 120, 121 may include a means for establishing, for example, an internet, Wi-Fi, Li-Fi, Wi-Max, LTE, HSPA, broad band, Bluetooth, or radio connections with each mobile device 102, 104, and in certain embodiments, the command center may be capable of transmitting instructions to each individual mobile device. Such instructions may supersede instructions or other communications from the remote computing device 110 or, in other embodiments, such instructions may be carried out in combination with communications from the remote computing device. For example, in some embodiments, the command center 120, 121 may transmit false intensity of the field information that supersedes the intensity of the field information provided by the remote computing device 110. In other embodiments, the command center 120, 121 may transmit additional instructions for displaying the location of the simulated source such as, for example, directional arrows, position coordinates, maps, and the like or combinations thereof. In some embodiments, the command center 120, 121 may transmit instructions for changing a frequency of measurement, thereby allowing, for example, the mobile device 102, 104 to obtain a more accurate reading and/or a different reading.

The command center 120, 121 may further be capable of providing instructions to the remote computing device 110 changing any parameters used to simulate the field, thereby modifying the source and the intensity of the field information received by the mobile device 102, 104. For example, if the remote computing device 110 is simulating a search for a radioactive source, the command center 120, 121 may provide instructions to the remote computing device that cause the remote computing device to simulate an explosion of a radioactive source, chemical munitions, or an improvised explosive device (IED). In some embodiments, the command center 120, 121 may be capable of providing instructions to one or more of the mobile devices 102, 104 receiving instructions from the remote computing device, and the instructions may change the operation of the mobile devices. For example, the command center 120, 121 may provide instructions to one or more of the mobile devices 102, 104 that cause one or more functions of the mobile devices, such as the display, audible signals, or position transmission to stop functioning. In another example, the command center 120, 121 may provide a report on a simulated health status of the user, such as, for example, incapacitated, injured, severely poisoned, and/or the like. In another example, the command center 120, 121 may provide instructions to one or more of the mobile devices 102, 104 that cause one or more functions of the mobile devices to change a frequency of a measurement. In another example, the command center 120, 121 may provide instructions to one or more of the mobile devices 102, 104 that cause one or more functions of the mobile devices to direct a user to perform one or more tasks, such as, for example, to change locations.

In still other embodiments, the command center 120, 121 may include additional means for communicating with each mobile device 102, 104 or a user of a mobile device. For example, the command center 120, 121 may include a cellular telephone transmitter, a radio, or another communication means that allow command center users to communicate with mobile device users.

In particular embodiments, the system described herein may be used as a training tool for First Responders. Training with actual live sources of radioactive material or chemical agents is expensive, dangerous, and unrealistic because training with live sources is often conducted in isolated areas, away from the locations in which training would be more realistic. Moreover, the sources used are often smaller than those expected in an actual emergency. Since training with sub-scale threats causes the training area to be smaller, possibly vastly smaller, than an actual emergency scene, First Responders and incident commanders are not trained as well as they could be. The use of simulated threats allows for the scope of training to match real world threat scenarios, and permits realistic training of both front-line responders and the back-up personnel who provide guidance.

When used for training exercises, a program may be activated on each mobile device 102, 104 or a stationary computing device used in the training exercise. In some embodiments, the activating step can be carried out manually by the mobile device user or command center personnel who cause the remote computing device 110 to activate the program on each mobile device. In other embodiments, the program may be activated automatically by the remote computing device. In some embodiments, activating the program may initiate a request for information that is sent to the remote computing device 110. After the remote computing device 110 receives the request for information, the remote computing device may automatically transmit instructions to preset protocols which employ time or one or more device sensors such as, temperature, location, acceleration, proximity, barometric pressure, electric field, magnetic field, and the like and combinations thereof. In other embodiments, activating the program may cause the mobile device to transmit location coordinates or other location information and other device sensor data to the remote computing device 110.

The remote computing device 110 may use the GPS or other location information received from the mobile device 102, 104 or the stationary computer to calculate an intensity for the field at the location of the mobile device based on the GPS or location data and the location of the simulated source. The intensity of the field at the mobile device 102, 104 may depend upon the type of simulated source, as described in greater detail herein. The field intensity may be modified to reflect movement of the mobile device 102, 104 as the user moves, and acting alone, or in teams, the user uses the information from his or her device, or from the multiple devices used by the team, to locate the source or map an affected area. Once the user, or team, has located the source, the remote computing device 110 may produce a signal indicating that the source has been identified.

In some embodiments, the training exercise may be carried out by the remote computing device 110 using a programmed protocol. In other embodiments, a command center 120, 121 operated by command center personnel such as training supervisors, training evaluators, referees, or cooperating members of a team may be in communication with the remote computing device 110, and may provide these command personnel with the location of the source and each mobile device 102, 104 communicating with the remote computing device. The command center personnel may coordinate the actions of an individual or team by issuing instructions to each mobile device user. In some embodiments, the command center personnel may cause the command center 120, 121 or remote computing device 110 to issue instructions to the mobile devices 102, 104 that cause the mobile devices to perform some action or transmit data. In certain embodiments, command center personnel may change the source properties or other simulation components before or during the training exercise.

Such systems can be used to train First Responder users to detect and locate these hazards. Such systems may also be used to train an incident commander, as described herein. Detection simulations can be designed for teams or single users seeking one or more sources. As discussed above, sources can be radioactive, chemical and biological materials. These sources can be localized to a single location or distributed over a particular area, and each source can be in fixed locations or moving during the simulation. The field produced by the source can be constant over time or may vary in emission intensity over time or based on weather conditions. In some embodiments, the various changes may be formulated based on plume-modeling software or replays of historical weather patterns. In particular embodiments, the mobile device 102, 104 may only display information from the remote computing device 110, and in other embodiments, the mobile device may use other sensors such as, for example, temperature, acceleration, proximity, video, photograph, barometric pressure, electric field, magnetic field, and the like to provide additional inputs (for example, auxiliary information) that can be incorporated into the simulation. In some embodiments, the remote computing device 110 may use available auxiliary information such as weather data, terrain properties, building locations, and the like derived from external sources or fabricated inputs, that can be incorporated into the simulation.

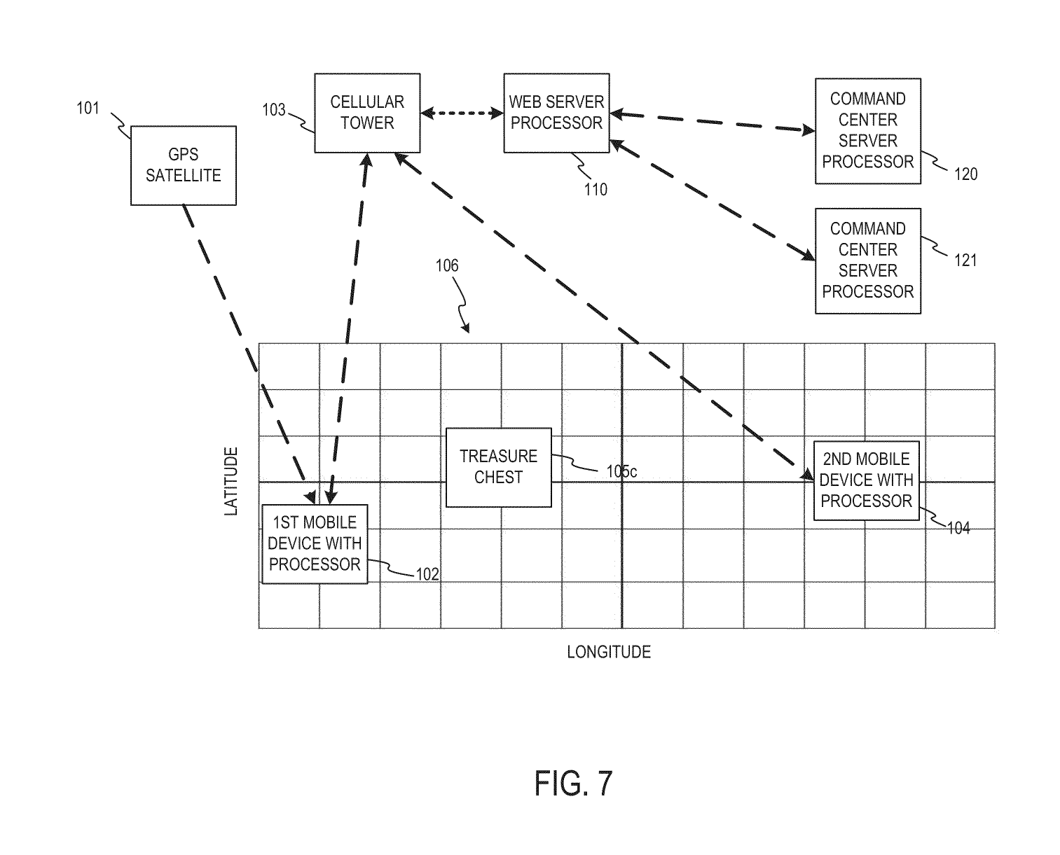

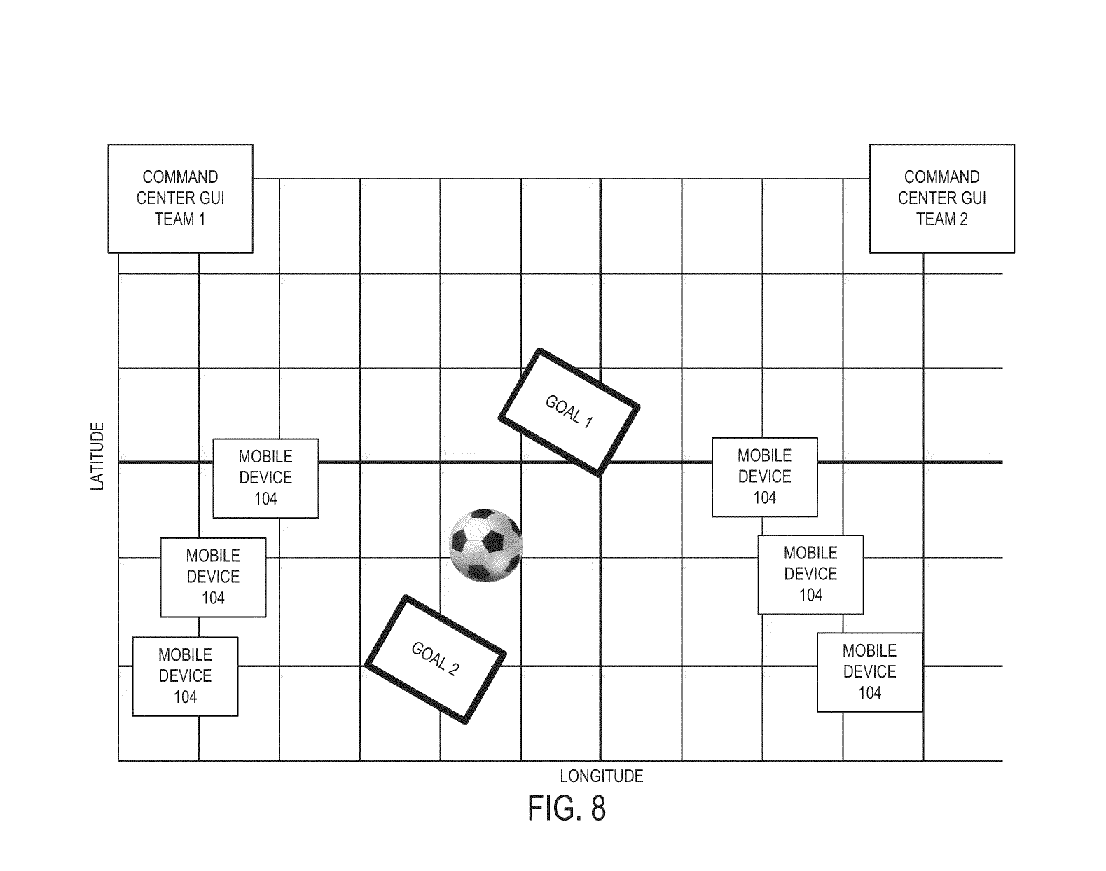

In some embodiments, the system described herein may be used for games such as treasure hunts, base running, virtual soccer, and hide and seek, as shown, for example, in FIG. 7. In the embodiment shown in FIG. 7, the source may be represented by a gamified target object 105c, such as, for example, a treasure chest. The various interactions described herein may similarly direct mobile devices and the users thereof with respect to the target object 105c. As also shown in FIG. 8, the remote computing device 110 may transmit information to each mobile device 104 relating to the distance between the mobile device and a fixed goal or moving component such as a ball. In some embodiments, such games could be used to train the public in the use of the real detection app that they can download for their mobile devices. Contests could be held using the simulator to interest the public individually and in teams to use the simulation app, but also in allowing their mobile devices to be used for actual radioactivity and chemical measurements. Encouraging the public to form teams to compete in the simulation contests could lead to large numbers of devices for crowd source-based homeland security protection. Apps for these games could be free to download, but could require that the app for actual radiological or chemical detection be employed also with the purpose of creating large numbers of devices for crowd source detection of hazards.

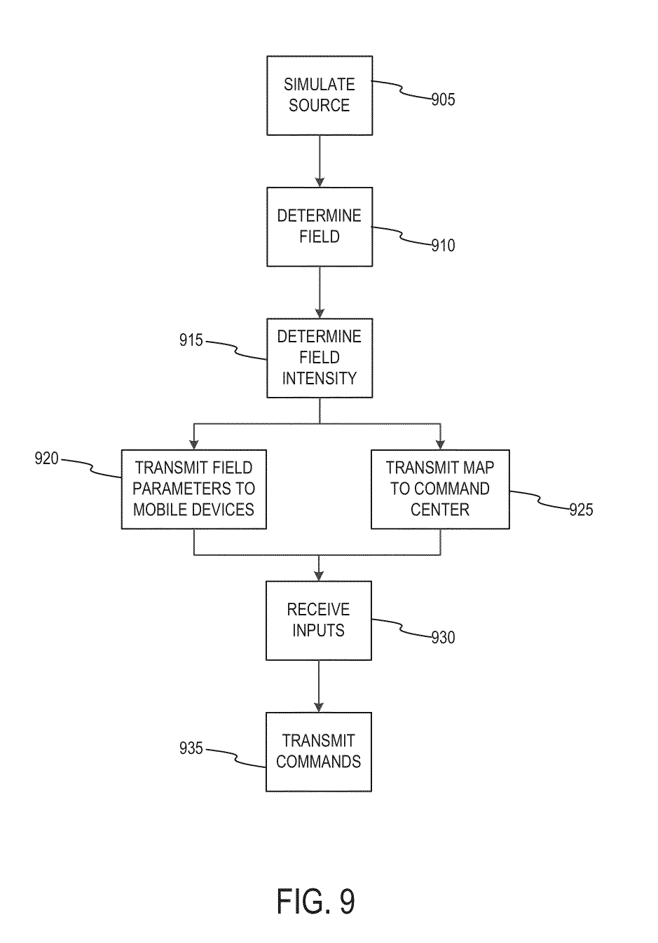

FIG. 9 depicts a flow diagram of a method of providing a simulation according to an embodiment. The method may be completed, for example, by the remote computing device described herein. In some embodiments, the source may be simulated 905, as described in greater detail herein. A field may be determined 910 based on the source and various other parameters described herein, such as, for example, temperature, wind speed, wind direction, presence and nature of structures, topological profile, humidity, altitude, barometric pressure, atmospheric composition, electric field, magnetic field, and/or the like. Similarly, the intensity of the field may be determined 915. The various parameters of the field, including a map or the like may be transmitted 920 to the one or more mobile devices and/or transmitted 925 to one or more command centers, as described in greater detail herein. Various inputs may be received 930 from the one or more mobile devices and/or the one or more command centers. As described in greater detail herein, one or more commands may be transmitted 935 to the one or more mobile devices and/or the one or more command centers, which may be based on the received 930 inputs, changing parameters, and/or the like.

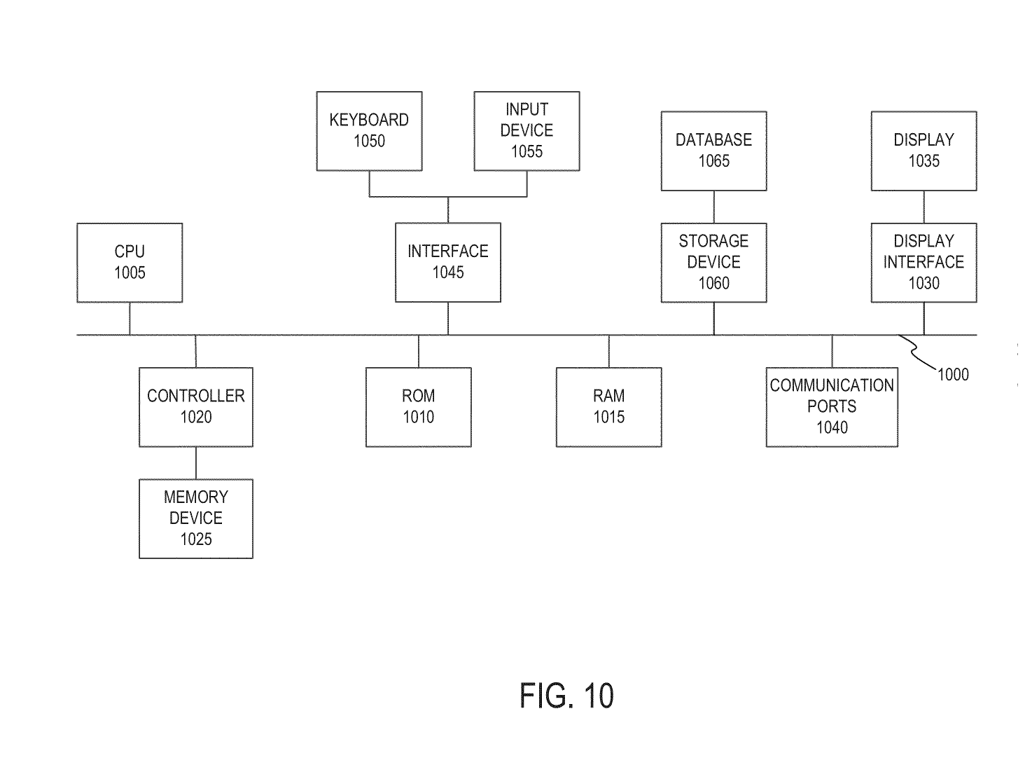

FIG. 10 depicts a block diagram of illustrative internal hardware that may be used to contain or implement program instructions, such as the process steps discussed herein, according to various embodiments. In some embodiments, the internal hardware may be a portion of a mobile device, as described herein. In other embodiments, the internal hardware may be a portion of a remote computing device, as described herein. In yet other embodiments, the internal hardware may be a portion of a command center, as described herein. A bus 1000 may serve as the main information highway interconnecting the other illustrated components of the hardware. A CPU 1005 is the central processing unit of the system, performing calculations and logic operations required to execute a program. The CPU 1005, alone or in conjunction with one or more of the other elements disclosed in FIG. 10, is an illustrative processing device, computing device or processor as such terms are used within this disclosure. Read only memory (ROM) 1010 and random access memory (RAM) 1015 constitute illustrative memory devices (such as, for example, processor-readable non-transitory storage media).

A controller 1020 interfaces with one or more optional memory devices 1025 to the system bus 1000. These memory devices 1025 may include, for example, an external or internal DVD drive, a CD ROM drive, a hard drive, flash memory, a USB drive, or the like. As indicated previously, these various drives and controllers are optional devices.

Program instructions, software, or interactive modules for providing the interface and performing any querying or analysis associated with one or more data sets may be stored in the ROM 1010 and/or the RAM 1015. Optionally, the program instructions may be stored on a tangible computer-readable medium such as a compact disk, a digital disk, flash memory, a memory card, a USB drive, an optical disc storage medium, such as a Blu-ray™ disc, and/or other non-transitory storage media.

An optional display interface 1030 may permit information from the bus 1000 to be displayed on the display 1035 in audio, visual, graphic, or alphanumeric format, such as the interface previously described herein. Communication with external devices, such as a print device, may occur using various communication ports 1040. An illustrative communication port 1040 may be attached to a communications network, such as the Internet, an intranet, or the like.

The hardware may also include an interface 1045 which allows for receipt of data from input devices such as a keyboard 1050 or other input device 1055 such as a mouse, a joystick, a touch screen, a remote control, a pointing device, a video input device and/or an audio input device.

The hardware may also include a storage device 1060 such as, for example, a connected storage device, a server, and an offsite remote storage device. Illustrative offsite remote storage devices may include hard disk drives, optical drives, tape drives, cloud storage drives, and/or the like. The storage device 1060 may be configured to store data as described herein, which may optionally be stored on a database 1065. The database 1065 may be configured to store information in such a manner that it can be indexed and searched, as described herein.

The computing device of FIG. 10 and/or components thereof may be used to carry out the various processes as described herein.

### EXAMPLES

Various aspects of embodiments disclosed will be illustrated with reference to the following non-limiting examples. The examples below are merely representative of the work that contributes to the teaching of the present invention, and the present invention is not to be restricted by the examples that follow.

### Example 1

A training event will occur over a several block area in Washington, D.C. using 4 smartphones and a tablet computer, each mobile device running an application with a user interface. The user interface will have a panel that allows a user to start the simulation by clicking on the “Start Reading” button of the mobile device user interface. This initiates the communication of the mobile device's current location to a web server and to a command center server. The command center server calculates the simulated radioactivity intensity at the mobile device location based on the distance from the simulated source or sources and any objects, such as buildings, walls or hills, in the path between the source and mobile device. The calculated radioactivity intensity is communicated back to the mobile device and presented on the user interface screen. It is also saved in a record. A screen of the user interface depicts readings that have been obtained as the user moves throughout the area. By measuring the simulated level, the trainee or team of trainees will locate a source by moving towards higher radioactivity values. Algorithms will assist the users by combining information from multiple readings and providing decision-support tools. These tools can include: contour plots, surface plots, the results of predictive calculations showing most likely location of the source, and guidelines of where one or more users should take new readings in order to best define the most likely location of the source.

### Example 2

Data was presented on a command center server processor user interface during a training exercise at the Disaster City facility in College Station, Tex. The simulated source location was shown by a radioactivity symbol on top of a building where the training exercise was conducted. The trainees were instructed to establish a cordon at radioactivity readings of 2 mR/hr, which is indicated by a cordon line in a map provided to the command center, similar to the cordon line 108 shown in FIG. 2. The symbols were color coded so that yellow symbols were readings at, or above, that level. This established a line on the command center screen at the cordon beyond which it was safe for the First Responders to operate and within which it was not. The incident commander could observe this scene on the command center user interface and direct the First Responders according to the readings. Thus, the incident commander was trained at the same time the First Responders in the field were trained. The training personnel observed and evaluated the performance of the First Responders and incident commander from the command center.

The radioactivity level at the mobile device for a simulated source placed at a predetermined location was calculated. The radioactivity intensities at any device location was computed using an A/r² dependence in which A is a constant related to the size of the source and r is the distance from the mobile device to the simulated source. The radioactivity intensities at any device location was computed by also using scenario-specific physics, such as air-attenuation of radiation, but could also include other physics formulae specific to other materials or fictional relationships arising from a game.

The radioactivity level at the mobile device for a simulated source placed at a predetermined location with a building between the source and mobile device was computed. The computation was performed as above using the A/r² dependence and the intensity at the mobile device was reduced by a factor B related to the building. The factor B is related to the thickness and material of the walls in the building that is traversed by the simulated radioactivity. In this way, shielding from nearby objects can attenuate the calculated signal, whereas in other circumstances objects can amplify a signal, much like a canyon focuses acoustic energy into an echo. As previously described herein, the distance r is the distance between the source and the mobile device, as depicted in FIG. 4.

For chemical detection training for a single searcher, the simulation app provides the simulated source's intensity at the user's location. The calculated source intensity is dependent on the kind of source and forces influencing their distribution such as the release rate and wind conditions. FIG. 5 depicts the spread of a constant leak in the absence of wind, being driven by both diffusion and convection. The chemical agent concentration would decrease with the distance from the source, but would increase in intensity over time at any given location. FIG. 6 depicts the spread of a constant leak in the presence of wind blowing towards the east. The wind moves the chemical spill towards the east. More complicated plume models, shielding models, and physics models can be applied for any situation.

### Example 3

A system for a treasure hunt game is depicted in FIG. 7. A treasure is hidden somewhere in the city. Two teams compete to find the treasure. Each team has members in the field and a captain in a command center. The teams receive information on the distance to the treasure. By spreading out, they can triangulate on the treasure and find it quickly. Games are played with a series of treasures and the winner is the team that finds all of the treasures in the fastest time.

The game can be played by individuals or by teams. Players use a “take readings” function to determine the distance from the mobile device location to the treasure. Moving and taking a series of readings allows the user to find the treasure. The first player to find the treasure, owns that treasure. The game can end or it can reset to respond to the position of a second treasure. “Treasures” could be discounts or free merchandise from an establishment (store, restaurant, entertainment venue) where each treasure is located. The establishment would gain publicity when the treasures are found and posted to the players.

### Example 4

FIG. 8 depicts another game called Park Soccer. The game is played with teams in a park or other safe location with a boundary. Each team registers to play and each team member signs on within the boundaries of the playing field (the local park). Each team's goal is preset by the game organizer or is the location where the first team member signed on. The first search is to find the ball which is hidden within the boundary. Team members use a “find function”, which determines distance from ball. The player finding the ball has control of the ball and can “kick” it a distance in any direction along a path or open field. The kick can be towards the goal or a teammate. The ball now shows up on all screens. The object is for each team to get ball to their goal. Opposing teams can take control of ball if they press the “find function” within a small distance (for example 20 feet) from the ball. Then the team member who got the ball can kick it towards their goal or team member. The team with the most goals in the time period (for example, 2 hours) wins. Each team can also have a captain with access to a command center server. The captain has the location and reading information for the players on both teams and can help coordinate the activities of his team by sending instructions to the mobile devices or information to the team members to optimize the chances of winning

What is claimed is:

1. A system comprising:
one or more mobile devices, each mobile device comprising a display, a processor, a position determination sensor, and a means for communicating with a remote computing device; and
a remote computing device having at least a processor, a means for communicating with each of the one or more mobile devices, and a readable storage medium containing instructions for:
simulating a source;
calculating a field associated with the source;
calculating an intensity of the field for each of the one or more mobile devices based on the location of the mobile device and a location of the source; and
transmitting the intensity of the field to each individual mobile device.

2. The system of claim 1, wherein the source is selected from the group consisting of simulated radioactive materials, simulated nuclear devices, simulated dirty bombs, simulated chemical agents, simulated biological agents, and combinations thereof.

3. The system of claim 1, wherein simulating the source comprises a source at a fixed specified geographical location and the instructions, multiple sources at multiple dispersed specified geographical locations, a distribution of sources distributed over specified geographical locations, and combinations thereof.

4. The system of claim 1, wherein the source moves.

5. The system of claim 1, wherein the intensity of the field for each of the one or more mobile devices is determined by a formula or numerical model selected from the group consisting of A/r² wherein A is a constant related to the size of a source and r is the distance from the simulated source to each of the one or more mobile devices.

6. The system of claim 1, wherein the intensity of the field for each of the one or more mobile devices are calculated based on attenuation caused by buildings, air, or terrain between each simulated source and each mobile device.

7. The system of claim 1, wherein the intensity of the field for each of the one or more mobile devices is modified based on weather data.

8. The system of claim 1, wherein each of the mobile devices transmit to the remote computing device auxiliary sensor data selected from the group consisting of temperature, pressure, acceleration, velocity, proximity, orientation, electric field, magnetic field, video, and still images.

9. The system of claim 8, wherein the readable storage medium further comprises instructions for using the auxiliary sensor data for computing the intensity of the field for each of the one or more mobile devices.

10. The system of claim 1, wherein each of the one or more mobile devices are configured to mimic a user interface of a detector selected from the group consisting of radiation detectors, Geiger counters, scintillation counters, radioisotope measurement devices, spectrometers, biological agent detection devices, chemical agent detection devices, and combinations thereof.

11. The system of claim 1, wherein the readable storage medium further comprises transmitting intensity of the field for each of the one or more mobile devices to each of the one or more mobile devices.

12. The system of claim 1, further comprising one or more command centers in communication with the remote computing device.

13. The system of claim 12, wherein the command center comprises a display and a command center computer readable storage media having instructions for displaying a map of a geographical area surrounding the simulated source and superimposing on the map the location of each of the one or more mobile devices.

14. The system of claim 13, wherein the command center computer readable storage media further comprises one or more instructions selected from the group consisting of displaying the field associated with the source, displaying the intensity of the field for each of the one or more mobile devices, or combinations thereof.

15. The system of claim 12, wherein the command center computer readable storage media comprises instructions for changing one or more variables associated with the source, the field, or combinations thereof based on user input and instructions for transmitting instructions to change the one or more conditions to the remote computing device.

16. The system of claim 15, wherein the one or more variables are selected from the group consisting of the type of source, the size of the source, the location of the source, weather conditions, building placement, terrain configuration, and combinations thereof.

17. The system of claim 12, wherein the command center further comprises a means for communicating with each of the one or more mobile devices.

18. The system of claim 17, wherein the command center receives auxiliary sensor data from each of the one or more mobile devices and the command center computer readable storage medium comprises instructions for using the sensor data for computing the intensity of the field for each of the one or more mobile devices.

19. The system of claim 12, wherein the command center is mobile.

20. The system of claim 1, wherein the source is released at variable rates.

21. The system of claim 1, wherein each of the one or more mobile devices comprise a computer readable storage medium having instructions for mimicking a user interface of a hazardous material detector.

22. The system of claim 20, wherein the hazardous material detector is selected from the group consisting of radiation detectors, Geiger counters, scintillation counters, radioisotope identification device, spectrometer, radio frequency detector, biological agent detection devices and chemical agent detection devices.

23. The system of claim 1, wherein each of the one or more mobile devices comprise computer readable storage medium having instructions for displaying the intensity of the field for each of the one or more mobile devices.

24. A method of providing a simulation comprising:
simulating, by a processor, a source;
determining, by the processor, a field surrounding the source, wherein the field is based upon one or more parameters;
determining, by the processor, an intensity of the field based upon the one or more parameters and a location relative to the source;
transmitting, by the processor, information to a mobile device, wherein the information corresponds to the source, the field, and the intensity of the field at the location of the mobile device;
transmitting, by the processor, the information to a command center;
receiving, by the processor, one or more commands from the command center, wherein the one or more commands direct a user of the mobile device to complete one or more instructions; and
transmitting, by the processor, the one or more commands to the mobile device.

25. The method of claim 24, wherein simulating the source comprises simulating one or more of a simulated radioactive material, a simulated nuclear device, a simulated Radiation Dispersal Device, a simulated chemical agent, and a simulated biological agent.

26. The method of claim 24, further comprising directing, by the processor, movement of the source.

27. The method of claim 24, wherein determining the intensity of the field comprises determining via the following formula:
A/r²
wherein A is a constant related to the size of a source and r is the distance from the source to the mobile device.

28. The method of claim 24, further comprising receiving, by the processor, auxiliary sensor data from the mobile device, wherein the sensor data comprises one or more of temperature, pressure, acceleration, velocity, proximity, orientation, electric field, magnetic field, video, and still images.

29. The method of claim 24, wherein the source is a gamified target object or field.

30. A system for providing a simulation comprising:
a processor; and
a non-transitory, processor-readable storage device, wherein the non-transitory, processor readable storage device comprises one or more programming instructions that, when executed, cause the processor to:
simulate a source,
determine a field surrounding the source, wherein the field is based upon one or more parameters,
determine an intensity of the field based upon the one or more parameters and a location relative to the source;
transmit information to a mobile device, wherein the information corresponds to the source, the field, and the intensity of the field at the location of the mobile device;
transmit the information to a command center;
receive one or more commands from the command center, wherein the one or more commands direct a user of the mobile device to complete one or more instructions; and
transmit the one or more commands to the mobile device.

31. The system of claim 30, wherein the one or more programming instructions that, when executed, cause the processor to simulate the source comprise one or more programming instructions that, when executed, cause the processor to simulate one or more of a simulated radioactive material, a simulated nuclear device, a simulated dirty bomb, a simulated chemical agent, and a simulated biological agent.

32. The system of claim 30, further comprising one or more programming instructions that, when executed, cause the processor to direct movement of the source.

33. The system of claim 30, wherein the one or more programming instructions that, when executed, cause the processor to determine the intensity of the field comprises comprise one or more programming instructions that, when executed, cause the processor to determine via the following formula:
A/r²
wherein A is a constant related to the size of a source and r is the distance from the source to the mobile device.

34. The system of claim 30, further comprising one or more programming instructions that, when executed, cause the processor to receive auxiliary sensor data from the mobile device, wherein the auxiliary sensor data comprises one or more of temperature, pressure, acceleration, velocity, proximity, orientation, electric field, magnetic field, video, and still images.

35. The system of claim 30, wherein the source is a gamified target object or field.
